(19) United States
(12) Patent Application Publication
(10) Pub. No.: US 2017/0159832 A1
(43) Pub. Date: Jun. 8, 2017

(54) PROPORTIONAL PRESSURE CONTROL VALVE

(71) Applicant: HYDAC FLUIDTECHNIK GMBH, Sulzbach/Saar (DE)

(72) Inventors: Philipp HILZENDEGEN, Wadern (DE); Peter BRUCK, Althornbach (DE); Frank SCHULZ, Blieskastel-Bierbach (DE)

(21) Appl. No.: 15/129,936

(22) PCT Filed: Mar. 5, 2015
(86) PCT No.: PCT/EP2015/000499

§ 371 Date: Sep. 28, 2016

(30) Foreign Application Priority Data
Apr. 2, 2014 (DE) 10 2014 004 796.2

(51) Int. Cl. F16K 3/34; F16K 31/06; F16K 11/07

(52) U.S. Cl. CPC F16K 3/34; F16K 11/07; F16K 31/0613; F16K 31/0675

(57) ABSTRACT

Disclosed is a proportional pressure control valve with a control piston (12) guided in a longitudinally movable manner in a valve housing (10), said control valve serving, by means of an actuating system (14), to selectively connect the connection points present in the valve housing, such as a pressure supply connection (P), a consumer connection (A) and a tank or return connection (T), wherein a first characteristic curve is produced between a control signal of the actuating system (14) and the flow volume or the control pressure (P), in relation to the consumer that can be connected to the consumer connection (A), wherein a second characteristic curve is produced for the consumer that can be connected to the consumer connection (A) of the valve housing (10) by means of a control device (65) after running through the first characteristic curve, the second characteristic curve differing to the first characteristic curve.

The invention concerns a proportional pressure control valve with a control piston guided in a longitudinally movable manner in a valve housing, said control valve serving, by means of an actuating system, to selectively connect the connection points present in the valve housing, such as a pressure supply connection, a consumer connection and a tank or return connection, wherein a first characteristic curve is produced between a control signal of the actuating system and the flow volume or the control pressure, in relation to the consumer that can be connected to the consumer connection.

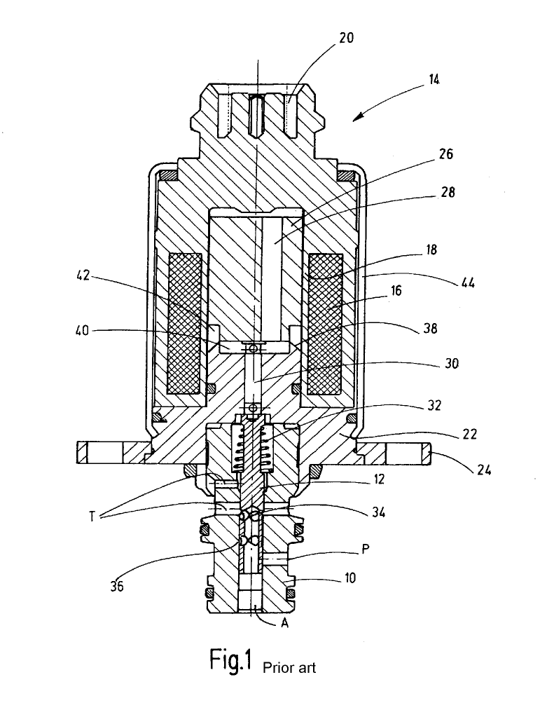

Proportional pressure control valves are known from prior art, for example under the order code PDMC04S30D according to the content of FIG. 1 of the enclosed special description. The known solution is a directly controlled 3-way proportional pressure control valve. When electrically de-energized, the pump connection or pressure supply connection is closed whereas the consumer connection is an open fluid connection to the tank or return connection. As soon as an electrical signal is applied, an actuating system in form of a magnet system applies pressure on the control piston that corresponds to the level of the control current, which causes said control piston to be longitudinally displaced against the force of a return spring and the fluid, in particular in form hydraulic oil, flows from the pump connection or pressure supply connection to the consumer connection along a linear characteristic curve. If the electrical signal is removed, the valve closes and returns again in reverse direction, following the preset characteristic curve, into the previous, non-actuated position.

As a result of the above-described valve control response, a linear pressure or volume flow control signal characteristic is created that is more than adequate for most applications of such proportional pressure control valves.

Proceeding from said prior art it is the object of the invention to further improve the known valve solution in such a way that it can be used in a greater range of applications whilst maintaining functional reliability and low production costs. A proportional control valve with the characteristics of claim 1 in its entirety meets said objective.

Because, according to the characterizing part of claim 1, a second characteristic curve, which differs from the first characteristic curve, is generated by means of a control device for the consumer that may be connected to the consumer connection of the valve housing after traversing the first characteristic curve, a different valve response is achieved for predefined applications of the pressure control valve, and thus the application spectrum for a proportional pressure control valve is increased significantly without diminishing the functional reliability or increasing the production costs compared to the known solution.

Despite the new creation of at least one further characteristic curve it is still possible to provide, without loss of resolution, a proportional setting for a hydraulic consumer that is connected to the valve solution.

In a preferred embodiment provision is made that the first characteristic curve is still linear, as described, and that following immediately at the end of the first characteristic curve, a ramp-like rising characteristic curve is generated by means of the control device. With this solution it is possible to let the pressure follow a linear curve up to a certain value of the electrical control signal, and then let it rise to a ramp-like increased working pressure. The realization of such a characteristic curve is particularly useful especially for clutch applications where increased advancing forces at the contact point of the clutch, or for disengaging the clutch disks from each other, are necessary.

In a preferred embodiment of the proportional pressure control valve according to the invention, the consumer that can be connected to the consumer connection of the valve is a manifold valve with at least one valve position that provides a kind of floating position for a further hydraulic consumer, which may be connected to the manifold valve, where said valve position is switched selectively based upon the ramp-like characteristic curve so that the said floating position may be switched in a defined black-and-white mode. Such a floating position is also approached proportionally in the prior art by using exclusively linearly rising characteristic curves for the pressure control valve, which in the end is at the expense of a good pilot valve resolution.

Further advantageous embodiments of the proportional pressure control valve according to the invention are subject of the dependent claims.

The pressure control valve according to the invention is described below in greater detail by way of an exemplary embodiment in accordance with the drawing. Shown are diagrammatically and not to scale in:

FIG. 1 a proportional pressure control vale according to the prior art in longitudinal section;

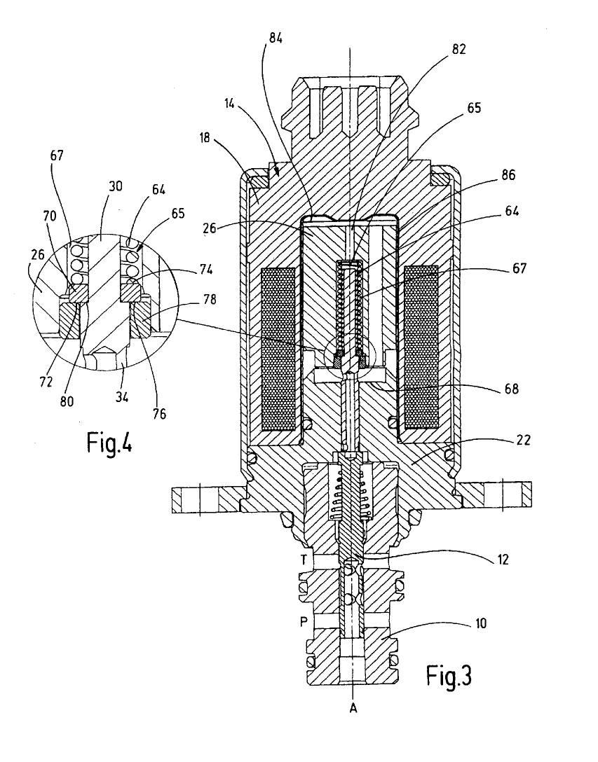

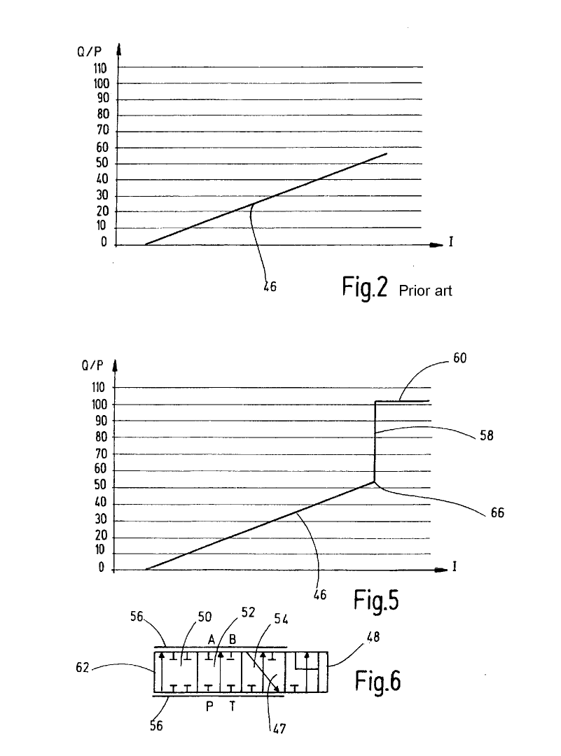

FIG. 2 a linearly rising characteristic curve that pertains to the valve solution of FIG. 1, which shows the electrical signal current I on the X axis and the pressure P or the volume flow Q on the Y axis;

FIG. 3 a diagram of a longitudinal section corresponding to the depiction of FIG. 1 of the proportional pressure control valve solution according to the invention;

FIG. 4 an enlarged section of a valve component according to FIG. 3 shown in a circle;

FIG. 5 a graph corresponding to FIG. 2, in which the linear characteristic curve shown in FIG. 2 is supplemented by a second curve in form of a ramp-like rise; and

FIG. 6 a manifold valve depicted through a commonly used hydraulic control circuit diagram, which is controlled by the pressure control valve according to the invention and which has a switchable floating position (shown on far right), whereas the remaining valve positions are proportionally controlled with a linear characteristic curve (the valve positions on the left in FIG. 6).

FIG. 1 shows in longitudinal section a known proportional pressure control valve comprising a control piston 12 that is longitudinally moveable and guided in valve housing 10, where said control piston 12 has the purpose of selectively connecting the connection points located in valve housing 10 by means of an actuating system that is identified as a whole by the number 14, a pressure supply connection P, a consumer connection A as well as a tank or return connection T. The actuating system shown in FIG. 1 is implemented in form of a magnet system; nevertheless, actuation by means of a pneumatic or other fluidic actuator (not shown) is also possible. Even a mechanical actuating system for the control piston 12 is possible in principle. The magnet system 14 comprises a coil winding 16 in a tubular coil former 18 in the usual manner, which is therefore not described in detail, in which the coil winding 16 with the respective actuating coil can be supplied with a control current via a connector 20. In the direction towards the valve housing 10 the tubular coil former 18 abuts a pole plate 22, which is surrounded towards its free end-face by a flange plate 24, which in turn is designed to fasten the pressure control valve to a valve block that is not shown in detail. In this manner it is possible to attach the pressure control valve shown in FIG. 1 to the not-depicted valve block in the manner of a cartridge insert. Said valve block is provided with connector positions that logically interact with the described connections P, A and T in valve housing 10.

Inside the tubular coil former 18 a longitudinally moveable armature 26 is guided, which comprises a pressure equalization duct 28 so as to enable a pressure-equalized, unobstructed reciprocating movement of the armature 26. As shown in FIG. 1, the cylindrical armature 26 is provided at its lower, free end-face with an actuating rod 30, which is permanently in contact with the control piston 12. To this end the control piston 12 is retained in permanent contact with the actuating rod 30 through an energy storage means in form of a compression spring 32 at its upper end, where the compression spring 32 attempts to retain the control piston in its uppermost position as shown in FIG. 1. In this de-energized position of the magnet system 14, and thus that of the armature 26, the consumer connection A is shut off from the pressure supply connection T by means of the control piston 12, which establishes an open fluid connection between the consumer connection A and the tank or return connection T through an upper series of bore holes 34. If the coil winding 16 is energized by way of connector 20, the armature 26 moves downward in the view seen in FIG. 1 and takes with it the control piston 12, via the actuating rod 30 and against the force of the compression spring 32, into a lower operating position. In said lower operating position an open fluid connection is provided between the pressure supply connection P and the consumer connection A via the lower series of bore holes 36 of the control piston 12 and, as a result of the closed outer wall circumference of the upper part of the control piston 12 the tank or return connection T is shut off from any kind of fluid supply.

To achieve a satisfactory lead-in of the magnetic forces from the coil winding 16 into the armature 26, the pole plate 22 features a conical-shaped control edge 38, which bounds a cylindrical center recess 40, with which the suitably guided armature 26 can engage in its movement downwards. The actual magnetic separation between pole plate 22 and armature 26 is achieved as usual via an air gap 42. Moreover, the entire arrangement of tubular coil former 18 with pole plate 22 is externally covered by a housing 44, which protects the inside of the magnet system 14 from the environment by means of seals at both of its ends. The design in this respect is conventional and is therefore not described in detail.

The proportional pressure control valve depicted in FIG. 1 is freely available on the market under the order number PDMC04S30D. This particular version is a directly-controlled 3-way proportional pressure control valve. When deactivated the pressure supply or pump connection P is closed, as shown in FIG. 1. Furthermore, the consumer connection A has an open fluid connection with the tank or return connection T via the control piston 12, as already described. As an electrical signal is applied, the armature 26 applies pressure on the control piston 12 with a force that is equal to that of the value of the control signal current I. This causes the control piston 12 to be pushed downwards, as per the diagram in FIG. 1, against the return spring in form of a compression spring 32, and the fluid medium, in particular in form of hydraulic oil, flows from the pressure supply connection P to the consumer connection A. As a result of a hydraulic consumer (not shown) that is connected to the consumer connection A, for example in form of a spool valve, a corresponding pressure builds up at the consumer connection A, which acts on the control piston surface of the control piston 12 and generates a corresponding counter force of the magnet system 14, which returns the control piston 12. This reduces the flow from the pump connection or pressure supply connection P to the consumer connection A until the pressure that is present at the consumer connection A corresponds to the magnetic force of the magnet system 14 and thus to the pressure setpoint through the current signal I.

If the hydraulic consumer is no longer in need of hydraulic fluid, which is the case for example if said spool valve is at the end stop, the control piston 12 moves further back and closes the supply port P according to the depiction in FIG. 1. If the initial pressure drops below the pressure setpoint due to a discharge of the connected consumer, the armature 26 pushes the control piston 12 down and the control process starts up again. The highest achievable control pressure is determined by the magnetic force of the magnet system 14. If the pressure at the consumer connection A increases above the setpoint value, the control piston 12 is pushed up by way of the armature 26 and opens the passage from the consumer connection A to the tank or return connection T. This limits the working pressure at the consumer connection A.

In the instance that the control current I is interrupted, the control piston 12 is pulled back due to the pressure at the consumer connection A and the force of the return compression spring 32. This connects the consumer connection A with the tank or return connection T and the pressure at the consumer connection A drops to the level of the tank pressure, which may correspond to the ambient pressure.

FIG. 2 depicts the qualitative curve showing the characteristic 46 of the control signal relative to pressure. Due to the selected actuator, the characteristic 46 is linear over the entire operating range. The first characteristic curve 46 shown in FIG. 2 thus extends linearly between the control signal in form of the control current I of the magnet actuating system 14 and the flow volume Q or the control pressure P, always in relation to a consumer that may be connected to the consumer connection A of the valve.

In some applications of such proportional pressure control valves it is possible that a differently-shaped characteristic curve or a different valve behavior of such a pilot valve is required. For example, in order to move a hydraulic consumer such as the one shown in FIG. 6 into the right-most floating position 48 when viewing FIG. 6, a characteristic control curve is required as shown in FIG. 5 for a proportional pressure control valve according to the invention as per FIGS. 3 and 4. According to the characteristic curve shown in FIG. 5 the volume flow curve Q or the pressure curve P required in principle is shown. With the pressure curve as shown it is possible to also move the hydraulic consumer 47, shown in FIG. 6, into the further valve positions 50, 52 and 54, shown to the left of the floating position 48, in a proportional manner according to the symbolic depiction of the double-line arrangement 56, which occurs immediately after the first linear characteristic curve 46 as per FIG. 5, without loss of resolution. Up to a certain control signal or current signal I the pressure follows a linear curve according the characteristic 46 as depicted in FIG. 5. At the end of the characteristic curve 46 the pressure or the volume flow rises ramp-like to an increased pressure or volume flow, where the respective further ramp-like characteristic curve is designated with 58. The further characteristic curve 58, which follows at the end of the first characteristic curve 46, permits a strong rise of the volume Q or the pressure P ramp-like in vertical direction, until at the end of the ramp-like step the vertical characteristic curve leads into a horizontal finishing characteristic 60, that is, despite an increasing control current I the volume flow Q as well as the pressure P remain constant along the finishing characteristic 60.

Since the control piston 12 via its connection ports P, A, T acts directly on the longitudinally moveable valve spool 62 of the hydraulic consumer according to FIG. 6, which is not shown in detail, the respective spool 62 is moved to one of its end stops at the ramp-like step of the further characteristic 58, 60, which corresponds to the fourth position 48, which causes a kind of floating position on a further hydraulic consumer that is connected to the consumer according to FIG. 6.

Said floating position may be switched in a defined black-and-white mode, whereas prior art pressure control valves as shown in FIG. 1 must be started proportionally to achieve such a floating position, which in the end equates to an unwanted loss of pilot valve resolution.

This pressure curve function with ramp-like rising characteristic curve 58, 60 as per FIG. 5 is achieved by a valve design according to the invention as shown in detail in FIGS. 3 and 4. The proportional pressure control valve design as per FIGS. 3 and 4 according to the invention is described below only to the extent to which it differs significantly from the solution according to the prior art. The same components that were already described with respect to FIG. 1 will have the same reference numbers in FIGS. 3 and 4. The respective descriptions apply then also for the solution according to the invention.

To achieve the characteristic curve according to FIG. 5, an armature compression spring 64 is pre-tensioned as part of a control device 65, which is disposed tightly fitting inside a cylindrical center recess 67 inside the armature 26, where the pre-tensioning is matched exactly to the force at the inflexion point 66 (cf. FIG. 5) of the pressure/control signal characteristic 46, 58, 60. Said internal armature compression spring 64 has no effect on the linear characteristic curve of the first characteristic 46 since the magnetic force is transferred to the pressure control piston 12 in the ratio of 1:1 despite the control device that is designed for this. As soon as the pre-tensioning force of the armature compression spring 64 is exceeded by the magnetic force of the magnet system 14 at a constantly increasing control signal or current signal I, the armature 26 moves further towards a pole surface 68 of the pole plate 22, which bounds the central recess 40 at the bottom as viewed in FIG. 1. The electromagnets used in this context for proportional pressure control valves have basically the attribute to follow a horizontal force/deflection characteristic within a presettable control range. However, said characteristic rises steeply the closer the armature 26 comes to the respective pole surface 68. This rising magnet force is utilized to let the pressure or the volume flow respectively rise suddenly according to the representation of the characteristic 58, 60, starting from said inflexion point 66 between the two characteristic curves 46, 58.

As shown in particular in the circular partial section of FIG. 4, the armature compression spring 64 is braced against a support means 70 at the lower end when viewed in FIGS. 3 and 4, which in turn is always in contact with the armature 26 in every position of the armature 26 due to the pre-tensioning of the armature compression spring 64. To achieve the latter embodiment of the characteristic, the annular support means 70 with its free end-face 72, which is located opposite the support surface 74 and the armature compression spring 64, is in permanent contact with a support collar 76 of a press-fit sleeve 78 that is inserted into armature 26. As shown in particular in FIG. 4, the support means 70 protrudes radially to the inside across the support collar 76 of the press-fit sleeve 78 and thus is braced against a further support collar 80 of the actuating rod 30. Whilst the press-fit sleeve 78 remains fixed in its location in the armature 26, the support means 70 is able to lift off from the press-fit sleeve 78 against the pressure of the armature compression spring 64 via the further support collar 80 of the actuating rod 30 provided that the actuating rod 30 is moved upwards when viewed in FIGS. 3 and 4.

The actuating rod 30 passes centrally through the armature compression spring 64 which, in the de-energized state of the magnet system 14, ends with its free upper end with a presettable distance to the armature 26, which is overlapped by the armature compression spring 64 with its free upper end. This distance is required so that the armature 26 is initially able to move freely against the force of the armature compression spring 64, which causes the linear characteristic curve 46. The armature compression spring 64 moves then into the “block” position, which is what generates the ramp-like rise of the further characteristic 58, 60.

It is evident that it is possible to use instead of the independent actuating rod 30 a corresponding extension that is an integral part of the control piston 12. Furthermore, the cylindrical central recess 67 in the armature 26 is provided at its upper end with a relief bore 82, which ends in the upper end of the armature space 84, in which said armature space 84 as well as parts of the pole plate 22 in the vicinity of the conical control edge 38 are enclosed by a pressure sleeve 86 as a component of the tubular coil former system.

For an average person skilled in the art in the field of pressure control valve technology it is surprising, and not present in the prior art, that it is possible to generate a hysteresis-like characteristic curve by using an additional armature compression spring 64, where first a linear characteristic curve and then a ramp-like characteristic curve 58 for the pressure P or the volume flow Q is generated.

1. Proportional pressure control valve with a control piston (12) guided in a longitudinally movable manner in a valve housing (10), said control valve serving, by means of an actuating system (14), to selectively connect the connection points present in the valve housing, such as
a pressure supply connection (P),
a consumer connection (A) and
a tank or return connection (T),
wherein a first characteristic curve (46) is produced between a control signal (I) of the actuating system (14) and the flow volume (Q) or the control pressure (P), in relation to the consumer (47) that can be connected to the consumer connection (A), characterized in that by means of a control device (65), and after traversing the first characteristic curve (46), a second characteristic curve (58, 60) is generated for the consumer (47) that may be connected to the consumer connection (A) of the valve housing (10), which differs from the first characteristic curve (46).

2. Pressure control valve according to claim 1, characterized in that the first characteristic curve (46) is linear and that, following immediately at the end (66) of the first characteristic curve (46), a ramp-like rising characteristic curve (58, 60) is generated by means of a control device (62).

3. Pressure control valve according to claim 1, characterized in that the actuating system is a magnet system (14), where the armature (26) of said magnet system (14) is guided longitudinally moveable by an electrically energizable coil arrangement (16) inside an armature housing (86) in order to actuate the control piston (12).

4. Pressure control valve according to claim 1, characterized in that the control device (62) comprises an energy storage means, preferably in form of an armature compression spring (64), which interacts with the armature (26) and the control piston (12) in such a way that the energy storage means transfers the magnetic force of the magnet system (14) at the ratio of 1:1 to the control piston (12) without influencing the linear first characteristic (46), and that, in the instance of exceeding a presettable energy threshold, preferably in form of a presettable pre-tensioning force of the armature compression spring (64), said presettable energy threshold is exceeded by the magnetic force generated through a constantly increasing control signal (I) and triggers the ramp-like rising characteristic curve (58, 60).

5. Pressure control valve according to claim 1, characterized in that the ramp-like characteristic curve (58, 60) is also forced by the increasing approximation of the armature (26) to a pole surface (68) of the magnet system (14).

6. Pressure control valve according to claim 1, characterized in that the armature compression spring (64) is fully integrated into the armature (26) and is supported at its one end by the armature (26) and at its other end by a support means (70), which is in every position of the armature (26) in contact with said armature (26) due to the pre-tensioning of the armature compression spring (64).

7. Pressure control valve according to claim 1, characterized in that the support means (70) is not only in contact with a support collar (80) of an actuating component, preferably in form of an actuating rod (30), for operating the control piston (12) or with the control piston (12) itself, but also with a further support collar (76) of a press-fit sleeve (78) that is solidly attached to the armature (26).

8. Pressure control valve according to claim 1, characterized in that the actuating rod (30) or the control piston (12) itself passes through the armature compression spring (64) which, in the de-energized state of the magnet system (14), ends with its one free end at a presettable distance to the armature (26), which is overlapped by the armature compression spring (64).

9. Pressure control valve according to claim 1, characterized in that the greatest possible free travel of the armature (26) extends from a conically-shaped control surface (38) to the pole surface (68) of a pole plate (22), through which the actuating rod (30) or the control piston (12) itself passes.

10. Pressure control valve according to claim 1, characterized in that integrated into the pole surface (68) is a part of the valve housing (10), which may be inserted into a valve block similar to a cartridge.

11. Pressure control valve according to claim 1, characterized in that the consumer (47) that may be connected to the consumer connection (A) is a manifold valve with at least one valve position (48) that facilitates a kind of floating position for a further hydraulic consumer, which may be connected to the manifold valve, and that this valve position is selectively switchable due to the ramp-like characteristic curve (58, 60), whereas the further valve positions (50, 52, 54) of the manifold valve may be proportionally controlled corresponding to the linear characteristic curve (46).
